(19) United States
(12) Patent Application Publication
(10) Pub. No.: US 2005/0230203 A1
(43) Pub. Date: Oct. 20, 2005

(54) Adjustable-length gas spring

(75) Inventors: Rainer Knapp, Deining (DE); Holger Knaust, Kummersbruck (DE); Erich Wornlein, Leinburg (DE)

Correspondence Address: BROWDY AND NEIMARK, P.L.L.C.;624 NINTH STREET, NW, SUITE 300, WASHINGTON, DC, 20001-5303, US

(73) Assignee: SUSPA Holding GmbH, Altdorf (DE)

(21) Appl. No.: 10/824,404

(22) Filed: Apr. 15, 2004

(30) Foreign Application Priority Data
Apr. 15, 2004 (DE) 103 17 174.6

(51) Int. Cl. F16F 9/22

(52) U.S. Cl. 188/322.17

(57) ABSTRACT

The invention comprises an adjustable length gas spring, having a casing which has a central longitudinal axis and is filled with a pressure fluid; a guide and seal unit which closes the casing at a first end thereof; a piston rod which has an outer end and is extended through, and sealed towards, the guide and seal unit out of the first end; a piston which is guided in, and sealed towards, the casing and connected with the piston rod; a first sectional casing chamber which is formed between the piston and the guide and seal unit; a second sectional casing chamber which is defined by the piston and faces away from the first sectional casing chamber; a valve which is disposed in the vicinity of the piston for interconnection of the sectional casing chambers, the valve having a valve pin, which is displaceable along the central longitudinal axis, for actuation of the valve from outside the casing; and at least one spring element, which is disposed between the piston and the first end of the casing, and which encircles the piston rod, and which supports itself on a side opposite the guide and seal unit, and which springily counteracts an extension of the piston rod for at least part of the length of extension.

### BACKGROUND OF THE INVENTION

1. Field of the Invention

The invention relates to an adjustable length gas spring.

2. Background Art

Lots of gas springs have been known. U.S. Pat. No. 4,949,941 teaches gas springs in which the valve is disposed within the piston and can be operated by a valve actuation rod that is disposed inside the hollow piston rod. Gas springs of this type have the drawback that the piston rod is extensible only as far as to a defined, pre-determined rigid stop. This rigid stop is felt to be insufficient in certain cases, in particular for applications with the piston rod loaded under tension.

### SUMMARY OF THE INVENTION

It is an object of the invention to improve prior art gas springs in such a way that any drawbacks involved will be overcome.

This object is attained in a gas spring comprising a casing which has a central longitudinal axis and is filled with a pressure fluid; a guide and seal unit which closes the casing at a first end thereof; a piston rod which has an outer end and is extended through, and sealed towards, the guide and seal unit out of the first end of the casing; a piston which is guided in, and sealed towards, the casing and connected with the piston rod; a first sectional casing chamber which is formed between the piston and the guide and seal unit; a second sectional casing chamber which is defined by the piston and faces away from the first sectional casing chamber; a valve which is disposed in a vicinity of the piston for interconnection of the sectional casing chambers, the valve having a valve pin, which is displaceable along the central longitudinal axis, for actuation of the valve from outside the casing; and at least one spring element, which is disposed between the piston and the first end of the casing, and which encircles the piston rod, and which supports itself on a side opposite the guide and seal unit, and which springily counteracts any extension of the piston rod for at least part of a length of extension. The gist of the invention resides in providing a spring element between the piston and the open end of the casing through which the piston rod is extended outwards. The is accompanied with the advantage that the piston rod is not pushed out against a rigid stop, there being a certain damping effect. Moreover, it is possible to extend the piston rod beyond the standard condition of extension. In this way, the gas spring obtains some additional lift of stroke, which is extraordinarily useful for certain applications.

Additional features and details of the invention will become apparent from the ensuing description of four exemplary embodiments, taken in conjunction with the drawing.

### BRIEF DESCRIPTION OF THE DRAWING

FIG. 1 is a longitudinal sectional view of a gas spring according to the first embodiment;

FIG. 2 is an illustration, on a strongly enlarged scale, of details of the view according to FIG. 1;

FIG. 3 is a longitudinal sectional view of a gas spring according to the second embodiment;

FIG. 4 is an illustration, on a strongly enlarged scale, of details of the view according to FIG. 3;

FIG. 5 is a longitudinal sectional view of a gas spring according to the third embodiment;

FIG. 6 is an illustration, on a strongly enlarged scale, of part of the view according to FIG. 5;

FIG. 7 is a longitudinal sectional view of a gas spring according to the fourth embodiment; and

FIG. 8 is an illustration, on a strongly enlarged scale, of details of the view according to FIG. 7.

### DESCRIPTION OF PREFERRED EMBODIMENTS

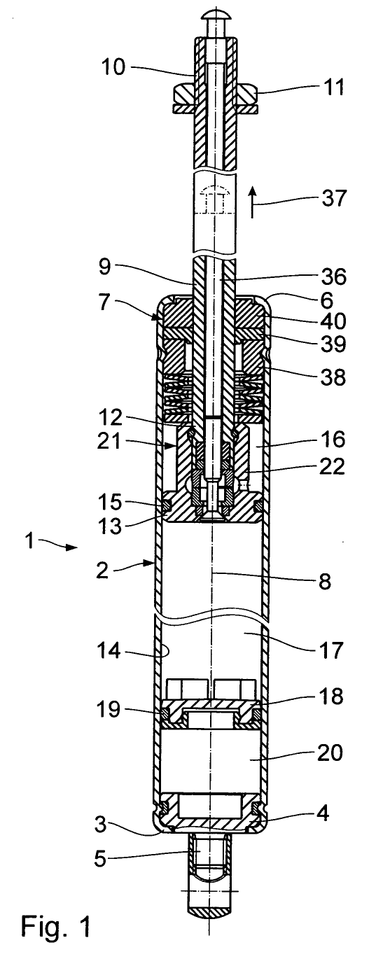

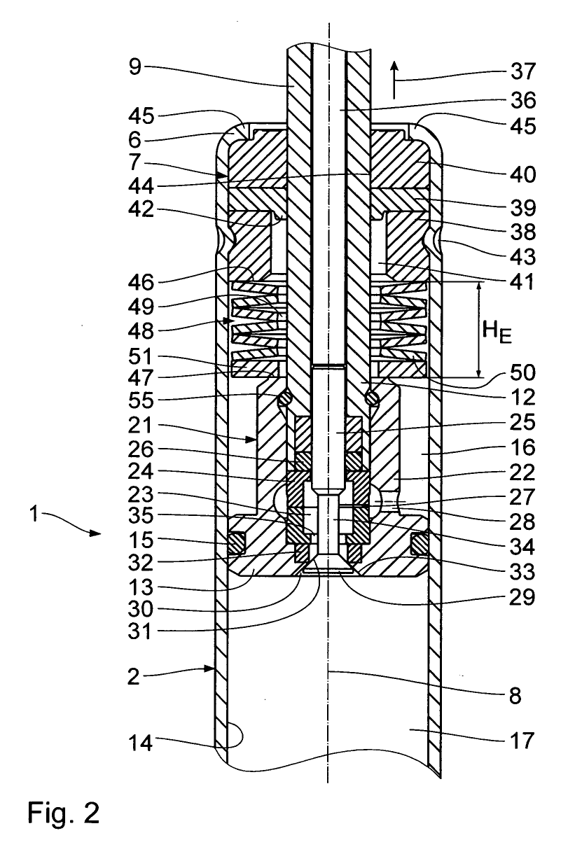

A first embodiment of the invention will be described in the following, taken in conjunction with FIGS. 1 and 2. An adjustable length, rigidly blockable gas spring 1 comprises a substantially cylindrical casing 2 made from a tube, a bottom 4 providing for gas-tight closure of a first end 3 of the casing 2. A fastening element 5 is mounted on the bottom 4. A liquid-tight annular guide and seal unit 7 is fixed to the second end 6 of the casing 2; it serves for guiding and sealing a piston rod 9 which is displaceable in the casing 2 concentrically of the central longitudinal axis 8 thereof. The free end 10, outside the casing 2, of the piston rod 9 is equally provided with a fastening element 11.

A piston 13 is mounted on the end 12, inside the casing 2, of the piston rod 9; it is guided on the inside wall 14 of the casing 2, towards which it is sealed liquid-tight by means of a seal 15. The piston 13 divides the interior of the casing 2 into a sectional casing chamber 16 that is located between the piston 13 and the guide and seal unit 7, and a sectional casing chamber 17 turned away therefrom. The sectional casing chamber 17 is again defined by a sliding piston 18, which is displaceable on the inside wall 14 of the casing 2 and sealed towards the wall 14 for gas- and liquid-tightness by means of a seal 19. A compressed-gas chamber 20 is disposed between the sliding piston 18 and the bottom 4, holding gas under pressure. The sectional casing chambers 16, 17 are filled with a fluid, for example hydraulic oil. A valve 21 is formed in the piston 13, by means of which to connect to, or separate from, one another the sectional casing chambers 16, 17. It comprises a valve body 22 which is located on the side of the piston 13 turned towards the seal and guide unit 7. A two-piece bush 24, which defines an overflow chamber 23, is disposed in the hollow valve body 22; a displaceable valve pin 25, which is coaxial of the axis 8, passes through the bush 24. By means of a seal 26, the valve pin 25 is sealed outwards between the bush 24 and the hollow piston rod 9. The overflow chamber 23 is permanently connected to the sectional casing chamber 16 by means of a throttle port in the bush 24. On its end turned towards the sectional casing chamber 17, the valve pin 25 comprises a valve disk 29 which is disposed in an aperture 30 connecting the valve 21 to the sectional casing chamber 17. By its sealing face 31 that is turned towards the bush 24, the valve disk 29 bears against a seal 32. This seal 32 bears against a bearing surface 33. The diameter of the valve disk 29 is smaller than the diameter of the connecting opening 30.

In the area between the overflow chamber 23 and the valve disk 29, the valve pin 25 has a tapered section 34; an annular channel 35 is formed between the tapered section 34 and the neighboring parts, namely the bush 24 and the seal 32, leading as far as to the valve disk 29. Disposed in the hollow piston rod 9 is a valve actuation rod 36, which is displaceable along the axis 8 and can be actuated from the end 10 by displacement and which bears against the valve pin 25. The valve actuation rod 36 is actuated by an actuation device (not shown) which is mounted on the end 10 of the piston rod 9, i.e. it is displaceable along the axis 8 and, if necessary, fixable in various axial positions. By a spring lock washer 55, the piston rod 9 is fixed in the axial direction in relation to the valve body 22; the spring lock washer 55 is lodged in corresponding recesses between the valve body 22 and the piston rod 9.

In the direction of extension 37, which is parallel to the axis 8, the guide and seal unit 7 successively comprises an annular cylindrical intermediary 38, an annular seal 39 that rests on the intermediary 38, and an annular closing piece 40 that rests on the seal 39. An annular gap 41 is formed between the intermediary 38 and the piston rod 9, with an annular sealing lip 42, which is integral with the seal 39, partially projecting into the gap 41. By way of several dome-shaped impressions 43 that are distributed along the circumference of the casing 2, the intermediary 38 is fixed axially in relation to the casing 2. The seal 39 rests sealingly on the piston rod 9 and on the inside wall 14, sealing the sectional casing chamber 16 towards the surroundings. The closing piece 40 has a hole 44 which is coaxial of the axis 8; the piston rod 9 is guided in the hole 44 substantially free from play. The closing piece 40 is fixed in place in the direction 37 by a crimping 45 of the casing 2 in the vicinity of the end 6.

A spring element 48 is arranged between the end of the intermediary 38 that is turned towards the sectional casing chamber 16, forming an annular bearing surface 46, and the end of the valve body 22 that extends in the direction 37, forming an annular bearing surface 47. The spring element 48 annularly encircles the piston rod 9, having a central hole 49, the diameter of which exceeds the outside diameter of the piston rod 9. The diameter of the hole 49 is dimensioned with corresponding play such that the spring element 48, even when askew, does not slide with friction on the piston rod 9 and does not produce any scratches that might affect the sealing of the sectional casing chamber 16. The outside diameter of the spring element 48 is selected for sufficient play to exist between the spring element 48 and the inside wall 14, the spring element 48 being displaceable along the axis 8. The spring element 48 includes several saucer springs 50 which rest in alignment one on top of the other and are preferably interconnected. In the present case, six saucer springs 50 of alternate deflection are arranged one on top of the other. Any other saucer spring arrangements are conceivable just as well. The successive arrangement of various types of saucer springs and the orientation thereof enables linear, progressive or degressive load-position characteristics to be set as desired. The special advantage in using saucer springs resides in that a rather short range is sufficient to build up major spring load. The additional lift of stroke conditioned by the spring element and the force required for compression are freely adjustable by the number of spring elements and the power of the spring elements. The spring element 48 used in the present case has for example a total lift of stroke of 3.6 mm—ranging between an entirely released condition and a totally compressed condition. In the entirely compressed condition, the counterforce produced is approximately 1500 N. It is possible to replace the saucer springs 50 of the spring element 48 by a compression spring or a flexible polymer block for example of rubber or polyurethane. Between the lowermost saucer spring 50 seen in FIG. 2 and the bearing surface 47, provision is made for an annular disk 51 which the lowermost saucer spring 50 bears against, the annular disk 51 supporting itself on the bearing surface 47. The disk 51 ensures as favorable as possible a transmission of power from the lowermost saucer spring 50 to the bearing surface 47 of inferior outside diameter.

The following is a detailed explanation of the basic functions of the gas spring 1 and of the properties that are added by the spring element 48. When, as compared to the position seen in FIG. 2, the rod 36 is pushed into the piston rod 9 counter to the direction 37, then the valve pin 25 is moved from the closing position seen in FIG. 2 towards the sectional casing chamber 17 into a valve-opening position, whereby the sealing face 31 of the valve disk 29 lifts off the seal 32 so that the sectional casing chamber 16 is connected to the sectional casing chamber 17 via the overflow channel 28, the throttling port 27, the overflow chamber 23, the channel 35 and the connecting aperture 30 so that, upon insertion of the piston rod 9 into the casing 2, hydraulic oil may flow from the sectional casing chamber 17 to the sectional casing chamber 16. This insertion takes place against the counterforce produced by the compressed gas in the compressed-gas chamber 20, with the sliding piston 18, upon this motion, being displaced in the direction towards the bottom 4, further compressing the compressed gas. If however the piston rod 9 is released with the valve 21 opened, it is pushed out of the casing 2 by the force of the compressed gas; the sliding piston 18 is moved away from the bottom 4. Consequently, the gas spring 1 is a compressed gas spring. When the actuation rod 36 is released, the valve pin 25 is again pressed into its closing position by the pressure acting in the sectional casing chamber 17. The piston 13, together with the piston rod 9, is then locked hydraulically rigidly in relation to the casing 2.

In the released condition, the spring element 48 has an axial height HE. As long as the axial distance between the bearing surface 47 and the bearing surface 46 exceeds HE, the spring element 48 can move freely in the axial direction in the sectional casing chamber 16. If the valve 21 is in the position of opening, the piston rod 9 is pushed outwards in the direction 37 until the distance between the bearing surfaces 46 and 47 is equal to H_{E}. With no external force acting between the fastening elements 5 and 11, the piston rod 9 is pushed slightly further out by the gas pressure in the compressed gas chamber 20, whereby the spring element 48 is slightly compressed. In the preferred embodiment, the force needed for compression of the spring element 48 exceeds—possibly strongly exceeds—the force exercised by the compressed gas chamber 20 so that, upon free extension of the piston rod 9, the spring element 48 is compressed only slightly. The spring element 48 therefore causes the free motion of extension of the piston rod 9 to be slightly damped.

There are applications of blockable adjustable length gas springs in which, between the fastening elements 5 and 11, tensile forces act on the piston rod 9 in the direction 37. If such a tensile force acts on the piston rod 9 and if the valve 21 is in the position of opening, then the spring element 48 is compressed against a corresponding spring counterforce and the pressure fluid is conveyed from the sectional casing chamber 16 into the sectional casing chamber 17. As a result, the gas spring 1, even when extended, possesses additional lift of stroke corresponding to the height to which the spring element 48 can be compressed in the axial direction. Corresponding to the load-position characteristic selected for the spring element 48, the gas spring 1 possesses additional springiness in the range of piston-rod-9 extension seen in FIG. 2, this springiness being relevant when a force of extension in the direction 37 acts on the piston rod 9. As long as the liquid column in the casing chambers 16, 17 does not break, any spring action by the spring element 48 will only take place when the valve 21 is in the position of opening. If, after compression of the spring element 48, the valve 21 is closed, the piston rod 9 is again pushed a little bit in, the spring element 48 thereby being substantially released and the sliding piston 18 moved in the direction towards the bottom 4. After extraction of the piston rod 9 in the direction 37 and cessation of the corresponding tensile force, the gas spring 1 exhibits a gentle restoring characteristic substantially back into the position seen in FIG. 2. Restoring depends on the relation of the load-position characteristics of the spring element 48 and the compressed gas chamber 20. The additional lift of stroke of the gas spring 1 can be put to use by means of the valve actuation device, acting only in the range of the piston-rod end position.

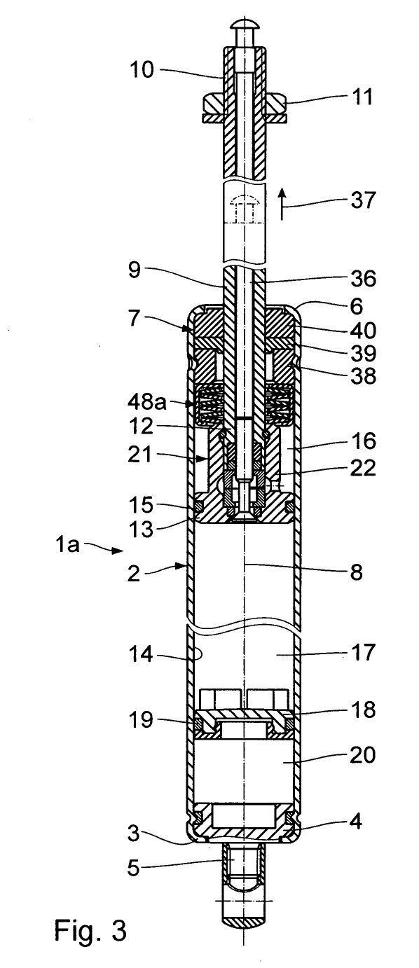

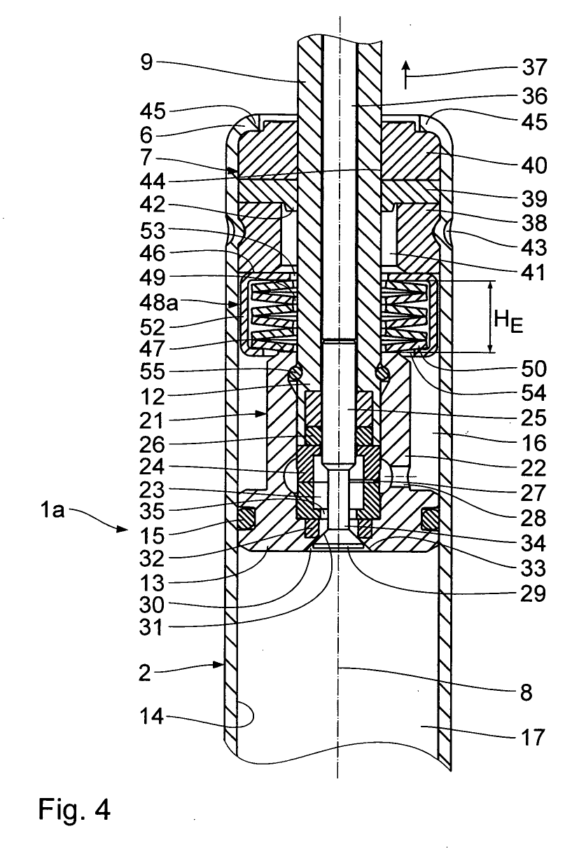

The following is a description of a second embodiment of the invention, taken in conjunction with FIGS. 3 and 4. Identical parts have the same reference numerals as in the first embodiment, to the description of which reference is made. Parts of identical function that differ constructionally, have the same reference numerals with an a added. As compared to the first embodiment, the substantial difference resides in that the spring element 48a is confined in the axial direction by an annular encapsulation 52. The end, located in the direction 37, of the encapsulation 52 has an aperture 53, the inside diameter of which slightly exceeds the diameter of the hole 49. The opposite end, facing away from the direction 37, of the encapsulation 52 is provided with an aperture 54, the diameter of which is selected such that sufficient distance is kept from the end of the valve body 22 that is oriented in the direction 37, confinement of the saucer springs 50 being ensured nonetheless. The diameter of the aperture 54 slightly exceeds the outside diameter of the valve body 22 so that the valve body 22 can be pushed into the encapsulation 52, it being possible thereby to compress the saucer springs 50. In the second embodiment, the bottom saucer spring 50 rests directly on the bearing surface 47, there being no need of a disk 51. The encapsulation 52 has the advantage of preventing any skew of the individual saucer springs 50 relative to each other, which otherwise would lead to the piston rod 9 becoming scratched. Moreover, it is possible to preload the spring element 48a by the aid of the encapsulation 52, which is necessary for certain load-position characteristics to be attained.

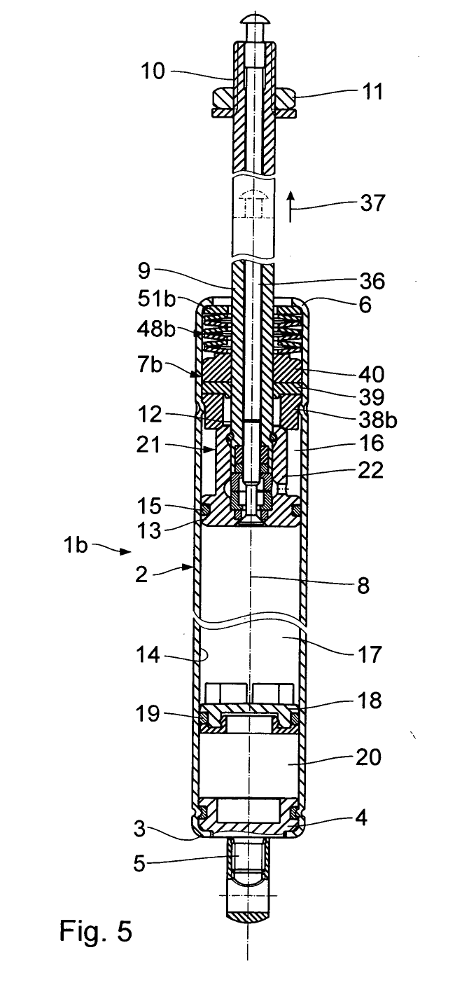

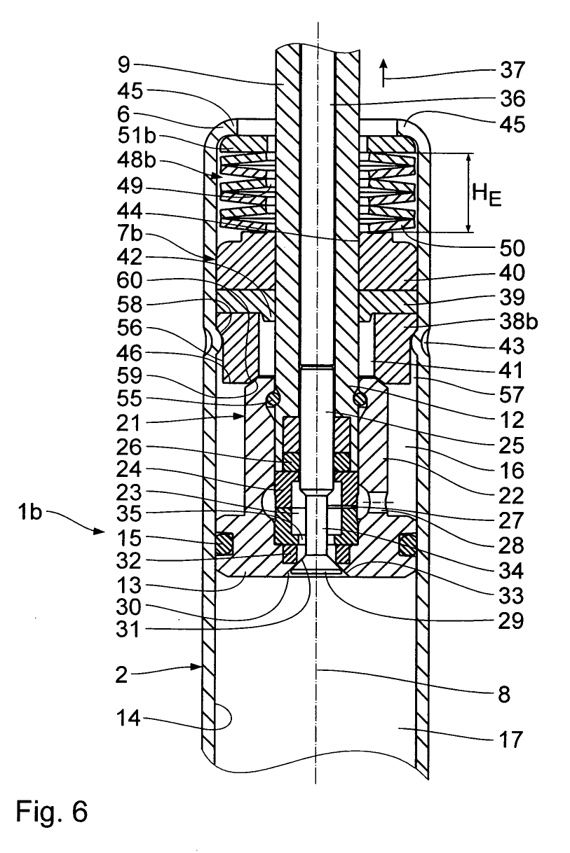

The following is a description of a third embodiment of the invention, taken in conjunction with FIGS. 5 and 6. Parts of identical construction have the same reference numerals as in the first embodiment, to the description of which reference is made. Parts of identical function that differ in construction have the same reference numerals with a b affixed. In the third embodiment, the spring element 48b is arranged outside the sectional casing chamber 16 between the end, facing in the direction 37, of the closing piece 40 and the crimping 45 of the casing 2. The spring assembly 50 is arranged in the same way as the saucer springs 50 in the encapsulation 52 of the second embodiment. The closing piece 40 and the seal 39 have the same design as in the first embodiment. The intermediary 38b differs by forming, between the inside wall 14 and the outer circumference 56 of the intermediary 38b, an annular gap 57 over part of its axial length starting from the end in the vicinity of the bearing surface 46. The annular gap 57 extends in the direction 37 for approximately two thirds of the axial length of the intermediary 38b, terminating in a conically expanding bearing surface 58 on which rest the inner sides of the impressions 43, as seen in FIG. 6. As a result of the annular gap 57, the intermediary 38b and thus the entire guide and seal unit 7b is displaceable from the position seen in FIG. 6 in the direction 37. With the bearing surface 58 cooperating with the impressions 43, there is no possibility of displacement of the intermediary 38b counter to the direction 37 beyond the position seen in FIG. 6. In the vicinity of its end that faces in the direction 37, the valve body 22 comprises an annular, conically tapering bearing surface 59 which cooperates with a corresponding, equally conically tapering bearing surface 60 on the end, located counter to the direction 37, of the intermediary 38b. The top saucer spring 50 supports itself by a disk 51b on the crimping 45 of the casing 2.

The basic function of the gas spring 1b corresponds to that of the first embodiment i.e., any displacement of the piston rod 9 is only possible when the valve 21 is in the position of opening. The major difference from the first two embodiments resides in that, even in any intermediate positions of the piston 13 i.e., even when the piston is not extended as seen in FIG. 6, the spring element 48b exhibits a damping effect in the case of tensile load. For damping in the case of tensile load, it is not even necessary that the valve 21 is in the position of opening. If tensile load acts on the gas spring 1b seen in FIGS. 5 and 6 when the valve 21 is closed, then the pressure fluid in the two sectional casing chambers 16 and 17 is pushed outwards, followed by the sliding piston 18. The pressure fluid in the sectional casing chambers 16, 17 causes the guide and seal unit 7b to be displaced in the direction 37, whereby the spring element 48b is compressed and the motion of extraction of the piston rod 9 is damped. As soon as the outward tensile load on the piston rod 9 ceases, the spring element 48b is released and the piston rod 9 is pushed inwards by the corresponding stroke. As opposed to the gas spring of the first embodiment, the additional lift of the gas spring 1b is active in any position of the piston rod 9.

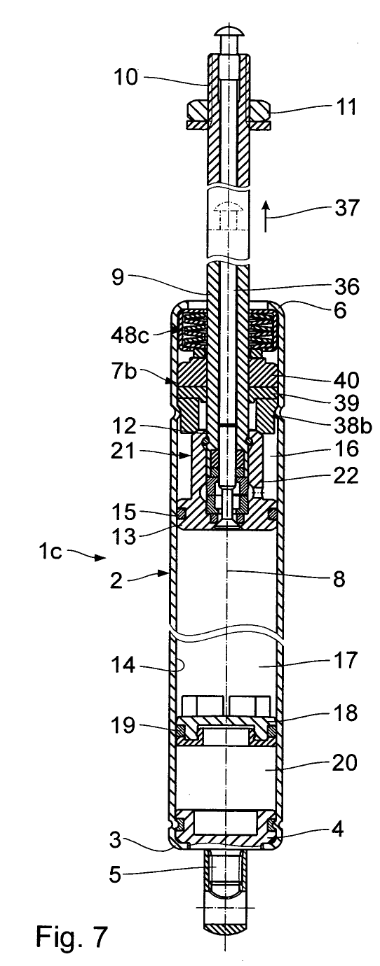

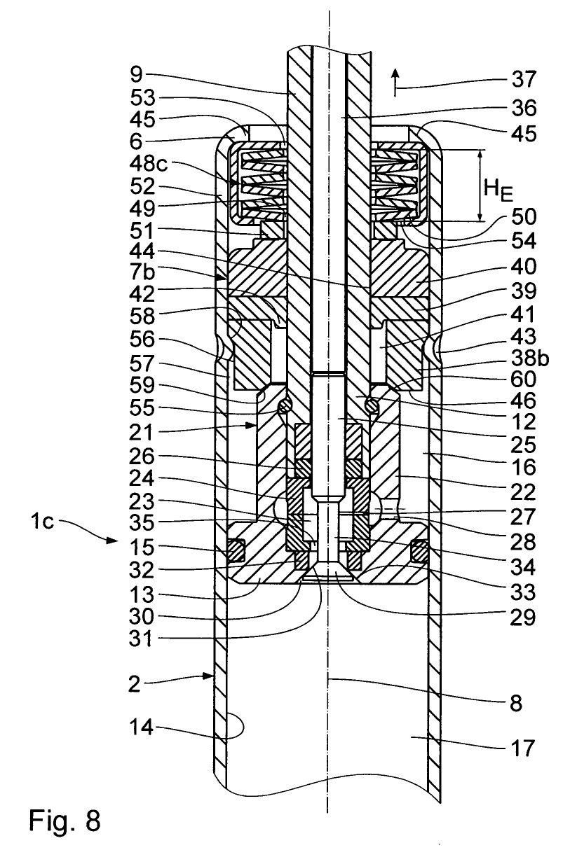

The following is a description of a fourth embodiment of the invention, taken in conjunction with FIGS. 7 and 8. Parts of identical construction have the same reference numerals as in the first embodiment, to the description of which reference is made. Parts of identical function that differ constructionally have the same reference numeral with a c affixed. The substantial difference of the fourth embodiment from the third embodiment resides in that the saucer springs 50 of the spring element 48c are confined by an encapsulation 52 as in the second embodiment. The advantages of the encapsulation are the same as in the second embodiment. Otherwise the function of the gas spring 1c corresponds to that of the gas spring 1b.

1. An adjustable length gas spring, comprising
a casing which has a central longitudinal axis and is filled with a pressure fluid;
a guide and seal unit which closes the casing at a first end thereof;
a piston rod which has an outer end and is extended through, and sealed towards, the guide and seal unit out of the first end of the casing, the piston rod being extendible relative to the casing;
a piston which is guided in, and sealed towards, the casing and connected with the piston rod;
a first sectional casing chamber which is formed between the piston and the guide and seal unit;
a second sectional casing chamber which is defined by the piston and faces away from the first sectional casing chamber;
a valve which is disposed in a vicinity of the piston for interconnection of the sectional casing chambers,
the valve having a valve pin, which is displaceable along the central longitudinal axis, for actuation of the valve from outside the casing; and
at least one spring element;
which is disposed between the piston and the first end of the casing,
which encircles the piston rod,
which supports itself on a side opposite the guide and seal unit, and
which springily counteracts any extension of the piston rod relative to the casing for at least part of a length of extension.

2. A gas spring according to claim 1, wherein the at least one spring element comprises at least one saucer spring.

3. A gas spring according to claim 2, wherein the at least one saucer spring element comprises an assembly of saucer springs.

4. A gas spring according to claim 3, wherein the assembly of saucer springs is confined by an encapsulation.

5. A gas spring according to claim 1, wherein the at least one spring element, upon extension of the piston rod, is supported towards the guide and seal unit in the direction of extension.

6. A gas spring according to claim 5, wherein the at least one spring element is disposed in the first sectional casing chamber.

7. A gas spring according to claim 1, wherein the guide and seal unit is displaceable in the casing.

8. A gas spring according to claim 7, wherein displaceability of the guide and seal unit counter to the direction of extension is defined by a stop.

9. A gas spring according to claim 7, wherein the at least one spring element is supported towards the guide and seal unit counter to the direction of extension.

10. A gas spring according to claim 1, wherein an energy accumulator is provided between the second sectional casing chamber and a closed second end, opposite the first end, of the casing.

11. A gas spring according to claim 1, wherein a gas-filled compensation chamber is provided between the second sectional casing chamber and a closed second end, opposite the first end, of the casing.

12. An adjustable length gas spring, comprising
a casing which has a central longitudinal axis and is filled with a pressure fluid;
a guide and seal unit which closes the casing at a first end thereof;
a piston rod which has an outer end and is extended through, and sealed towards, the guide and seal unit out of the first end of the casing, the piston rod being extendible relative to the casing;
a piston which is guided in, and sealed towards, the casing and connected with the piston rod;
a first sectional casing chamber which is formed between the piston and the guide and seal unit;
a second sectional casing chamber which is defined by the piston and faces away from the first sectional casing chamber;
a valve which is disposed in a vicinity of the piston for interconnection of the sectional casing chambers,
the valve having a valve pin, which is displaceable along the central longitudinal axis, for actuation of the valve from outside the casing; and
at least one spring element,
which is disposed in the first sectional casing chamber between the piston and the guide and seal unit,
which encircles the piston rod,
which supports itself on a side opposite the guide and seal unit, and
which springily counteracts any extension of the piston rod relative to the casing for at least part of a length of extension.

13. A gas spring according to claim 12, wherein the at least one spring element comprises at least one saucer spring.

14. A gas spring according to claim 13, wherein the at least one saucer spring comprises an assembly of saucer springs.

15. A gas spring according to claim 14, wherein the assembly of saucer springs is confined by an encapsulation.

16. A gas spring according to claim 12, wherein the at least one spring element, upon extension of the piston rod, is supported towards the guide and seal unit in the direction of extension.

17. A gas spring according to claim 12, wherein an energy accumulator is provided between the second sectional casing chamber and a closed second end, opposite the first end, of the casing.

18. A gas spring according to claim 12, wherein a gas-filled compensation chamber is provided between the second sectional casing chamber and a closed second end, opposite the first end, of the casing.

19. An adjustable length gas spring, comprising
a casing which has a central longitudinal axis and is filled with a pressure fluid;
a guide and seal unit which closes the casing at a first end thereof;
a piston rod which has an outer end and is extended through, and sealed towards, the guide and seal unit out of the first end of the casing, the piston rod being extendible relative to the casing;
a first fastening element mounted on the outer end of the piston rod;
a second fastening element mounted on a closed second end of the casing;
a piston which is guided in, and sealed towards, the casing and connected with the piston rod;
a first sectional casing chamber which is formed between the piston and the guide and seal unit;
a second sectional casing chamber which is defined by the piston and faces away from the first sectional casing chamber;
a valve which is disposed in a vicinity of the piston for interconnection of the sectional casing chambers,
the valve having a valve pin, which is displaceable along the central longitudinal axis, for actuation of the valve from outside the casing; and
at least one spring element,
which is disposed between the piston and the first end of the casing,
which encircles the piston rod,
which supports itself on a side opposite the guide and seal unit, and
which springily counteracts any extension of the piston rod relative to the casing for at least part of a length of extension, whereas the at least one spring element is constructed such that with the valve being in an open position and with no external force acting between the fastening elements it is slightly compressed and with the valve being in an open position and with a tensile force acting between the fastening elements it can additionally be compressed in the direction of extension.

20. A gas spring according to claim 19, wherein the at least one spring element comprises at least one saucer spring.

21. A gas spring according to claim 20, wherein the at least one saucer spring comprises an assembly of saucer springs.

22. A gas spring according to claim 21, wherein the assembly of saucer springs is confined by an encapsulation.

23. A gas spring according to claim 19, wherein the at least one spring element, upon extension of the piston rod, is supported towards the guide and seal unit in the direction of extension.

24. A gas spring according to claim 23, wherein the at least one spring element is disposed in the first sectional casing chamber.

25. A gas spring according to claim 19, wherein the guide and seal unit is displaceable in the casing.

26. A gas spring according to claim 25, wherein displaceability of the guide and seal unit counter to the direction of extension is defined by a stop.

27. A gas spring according to claim 25, wherein the at least one spring element is supported towards the guide and seal unit counter to the direction of extension.

28. A gas spring according to claim 19, wherein an energy accumulator is provided between the second sectional casing chamber and the closed second end, opposite the first end, of the casing.

29. A gas spring according to claim 19, wherein a gas-filled compensation chamber is provided between the second sectional casing chamber and the closed second end, opposite the first end, of the casing.
